(19) United States
(12) Patent Application Publication
(10) Pub. No.: US 2001/0018087 A1
(43) Pub. Date: Aug. 30, 2001

(54) SHELF STABLE CREAM CHEESE PRODUCT

(76) Inventors: EDWARD C. COLEMAN, NEW FAIRFIELD, CT (US); TWYLA P. STUBBLEFIELD, CHESTNUT RIDGE, NY (US); EILEEN M. HALLIDAY, POUGHKEEPSIE, NY (US)

Correspondence Address: KRAFT FOODS INC, 555 SOUTH BROADWAY, TARRYTOWN, NY, 10591

(21) Appl. No.: 09/310,315

(22) Filed: May 12, 1999

Related U.S. Application Data
(60) Provisional application No. 60/049,059, filed on Jun. 10, 1997.

(51) Int. Cl. A23C 19/097

(52) U.S. Cl. 426/324; 426/582

(57) ABSTRACT

A cream cheese product storable at normal room temperature for at least 6 months without substantial bacteriological deterioration comprising cream cheese, including cream cheese analogs and substitutes, and an edible acid in an amount sufficient to provide a pH of less than about 4.5, and methods for producing the same.

### BACKGROUND OF THE INVENTION

The present invention relates generally to cream cheese products and, more particularly, to cream cheese products having an extended shelf-life at room temperatures.

### DESCRIPTION OF THE PRIOR ART

Cream cheese products, including analogous reduced-fat and/or flavored cream cheeses and cream cheese analogs and substitutes, are important items in the diets of many consumers. Cream cheese products find favor as spreads for breads and crackers, as well as components in dressings and dips.

Cream cheese products are normally shipped and stored at refrigerated temperatures in order to prolong their shelf-life. Conventional cream cheese products have a shelf-life of weeks or even months at refrigerator temperatures. However, these cream cheese products are not particularly stable at room temperatures, either in the original package or after the package is opened.

It would be highly desirable to provide cream cheese products which are stable at ordinary room temperatures. In particular, it would be desirable to provide cream cheese products which are capable of mass distribution under non-refrigerated conditions and which could be stored at normal room temperatures for several months.

### SUMMARY OF THE INVENTION

It is the principal object of the present invention to provide cream cheese products which are adapted for storage at room temperature for extended periods of time without substantial microbiological deterioration. It is another object of the present invention to provide a method for making nutritious, palatable cream cheese products, which are capable of storage for extended periods of time at room temperature without substantial microbiological deterioration. It is a further object of the present invention to provide cream cheese products suitable for use as spreads, as part of an individual packaged snack item, capable of storage for extended periods of time at room temperature without substantial microbiological deterioration. Other objects and advantages of the present invention will be apparent from the following description and the appended claims.

In accomplishing the aforesaid objects, the present invention contemplates a process wherein a cream cheese material is treated with an edible acid to provide a pH of less than about 4.5, and thereafter packaged in a conventional manner to provide a product adapted for distribution and storage at normal room temperatures. The cream cheese products may also contain conventional emulsifying agents, antimycotic agents and anti-syneresis agents. The shelf stable cream cheese products of the present invention have organoleptic properties approaching those of conventional cream cheese.

### DETAILED DESCRIPTION OF THE PREFERRED EMBODIMENT

The cream cheese product of the present invention is prepared either from conventional (i.e. full-fat) cream cheese, reduced-fat and no-fat cream cheese, flavored cream cheese and/or cream cheese analogs or substitutes. Cream cheese analogs or substitutes are typically products wherein at least a portion of dairy fat is replaced by partially hydrogenated vegetable oil. As used herein the term “cream cheese material” is meant to include all of the above-mentioned types of cream cheeses and analogs and substitutes therefor. A cream cheese material, typically having a pH of about 4.55 to 5.0, is heated to a temperature sufficient to fluidize the same, normally to a temperature of about 150° F. (65.5° C.). Heating may be done in any conventional manner; however, a steamjacketed, scraped-surface kettle or a laydown cooker have proven to be useful. If, as in the case of a laydown cooker, injected steam is utilized to heat the cream cheese, it may be desirable to reduce the moisture content of the cream cheese to be heated, since as much as 5-10% by weight of moisture may be added as injected steam. Desirably, to the fluidized cream cheese material are added a suitable emulsifier, antimycotic agent and anti-syneresis agent. Alternatively, the emulsifying agent, antimycotic agent, and anti-syneresis agent may be incorporated in the mix which is used to prepare the cream cheese material which is subsequently treated in accordance with the present invention.

To the fluidized cream material containing the desired emulsifier, antimycotic agent and anti-syneresis agent, an edible acid in an amount sufficient to reduce the pH of the mixture to below about 4.5, and preferably to about 4.2 to 4.4, is added. Upon reaching equilibrium conditions at the desired pH, the mixture may be heated to pasteurization conditions, after which the temperature may be adjusted to the desired temperature for packaging. Preferably, the packaging material should be opaque to reduce oxidative deterioration of any fat present in the cream cheese product of the present invention.

The emulsifying agent may be a chemical emulsifier having a high HLB (hydrophilic/lipophilic balance), preferably above 10, most preferably above about 15, and/or an emulsifying salt, such as disodium phosphate. Emulsifying salts, while not being chemical emulsifiers, are known in the cheese art to enhance the emulsifying properties of proteins contained in the cheese. They are useful in the present invention to prevent oiling out during melting of the cream cheese material. Suitable chemical emulsifiers are sodium stearoyl lactylate, polyoxyethylene sorbitan esters (e.g., polysorbate 60), and sorbitan esters (e.g., sorbitan monostearate). Sodium stearoyl lactylate has been found to produce the most desirable creamy texture in the cream cheese product of this invention.

Antimycotic compounds which may be utilized in accordance with the present invention include potassium sorbate, sorbic acid, benzoic acid, sodium benzoate, calcium propionate, or mixtures thereof. The antimycotic agent is added in an amount of between about 0.05% and 0.2% by weight.

Suitable anti-syneresis agents include modified food starches, an example of which is THERMFLO® modified waxy maize starch available from National Starch and Chemical Corporation, P.O. Box 6500, Bridgewater, N.J. 088807. Other suitable modified food starches which cook-up at around 170° F. are known to persons skilled in the art, such as FRIGEX®, HV, H or W, PURITY® W, THERMTEX®, all products of National Starch and Chemical Company. Gums such as carob, locut bean, quar, xanthan and/or carrageenan could be used in place of all or a portion of starch; however, the level of gum must be controlled to avoid imparting an adverse texture to the cream cheese product.

The edible acid should be compatible in flavor with the cream cheese products. Examples of suitable edible acids are lactic, adipic, fumaric and gluconic acids, glucono delta lactone, and phosphoric acid. Phosphoric acid has been found to be preferred as it produces the cleanest flavor profile for the cream cheese product of this invention.

The shelf-life of the cream cheese products of the present invention at normal room temperature will extend for at least 6 months, and in most cases for a year or more. The limiting factor on shelf-life may be the susceptibility of any fat in the cream cheese product to oxidation, resulting ultimately in rancidity. Oxidation of fat can be minimized by the use of opaque packaging materials and, optionally, the addition of antioxidants. The choice of antioxidants will be apparent to persons skilled in the art. Tertbutyl hydroquinone (TBHQ), butylated hydroxyanisole and/or butylated hydroxytoluene would be a suitable antioxidant.

### EXAMPLE I

Conventional full-fat cream cheese (comprised of milk, cream, salt, cheese cultures and gum (xanthan, carob and/or guar) stabilizers) is heated to about 150° F. (65.5° C.), at which temperature the cream cheese is in a fluid state the emulsifying agent, sodium stearoyl-lactylate, is added thereto at a level sufficient to provide a level of about 0.147% by weight in the final cream cheese product. Also added is THERMFLO® modified waxy maize starch, an anti-syneresis agent, at a level sufficient to provide about 0.939% by weight in the final cream cheese product. The resultant mixture is stirred for a period of time sufficient to ensure thorough admixture, typically three to five minutes.

Thereupon, a 50% aqueous solution of potassium sorbate, an antimycotic agent, is added in an amount sufficient to provide a level of about 0.05% by weight of potassium sorbate in the final cream cheese product. Mixing is continued for an additional period of time, typically three to five minutes.

Thereupon, phosphoric acid (85% concentration) is added to the mix at a level to provide about 0.246% by weight in the final cream cheese product. Mixing is continued for a suitable length of time, whereupon the mixture is heated to about 165-175° F. (73.9-79.4° C.). and held at that temperature for about one minute. Thereupon, the mixture is cooled to 150-155° F. (65.5-68.3° C.), and packaged in opaque containers.

The resultant cream cheese product may be stored at room temperature for a period of time up to at least about one year, without significant bacteriological deterioration. The organoleptic properties of the cream cheese product are substantially the same as those of cream cheese.

The composition by weight of the resultant cream cheese product is as follows:

| Ingredient | Percent by Weight |
|---|---|
| Cream Cheese | 98.568 |
| Potassium Sorbate | .05 |
| Water to Dissolve Potassium Sorbate | .05 |
| Sodium Stearoyl Lactylate | .147 |
| Phosphoric Acid | .246 |
| THERMFLO ® Starch | .939 |

### EXAMPLE II

The method set forth in Example I above is repeated, at a slightly increased level of potassium sorbate and a slightly decreased level of phosphoric acid. The resultant cream cheese product had the following composition:

| Ingredient | Percent By Weight |
|---|---|
| Cream Cheese | 98.470 |
| Potassium Sorbate | .10 |
| Water to Dissolve Potassium Sorbate | .10 |
| Sodium Stearoyl Lactylate | .147 |
| Phosphoric Acid | .244 |
| THERMFLO ® Starch | .939 |

The organoleptic properties of the resultant cream cheese product were substantially similar to those of full fat cream cheese, and the shelf-life of the cream cheese product was substantially the same as that set forth in Example I.

### EXAMPLE III

The method set forth in Example I is repeated, at a slightly increased level of potassium sorbate. The composition of the resultant cream cheese product is as follows:

| Ingredient | Percent By Weight |
|---|---|
| Cream Cheese | 98.368 |
| Potassium Sorbate | .150 |
| Water to Dissolve Potassium Sorbate | .150 |
| Sodium Stearoyl Lactylate | .147 |
| Phosphoric Acid | .246 |
| THERMFLO ® Starch | .939 |

The organoleptic properties of the cream cheese product were substantially the same as those set forth in Example I, and the shelf-life was also substantially the same.

### EXAMPLE IV

The method of Example I was repeated, but in addition to the ingredients set forth in Example II, sucrose was added with the starch, to provide a cream cheese product having the following composition:

| Ingredient | Percent By Weight |
|---|---|
| Cream Cheese | 97.37 |
| Potassium Sorbate | .10 |
| Water to Dissolve Potassium Sorbate | .10 |
| Sodium Stearoyl Lactylate | .15 |
| Phosphoric Acid | .24 |
| THERMFLO ® Starch | .93 |
| Sugar | 1.11 |

The organoleptic properties and the shelf-life of the cream cheese product were substantially the same as those set forth in Example I.

### EXAMPLE V

The method of Example IV was repeated, except that salt was also added with the sugar, to provide a cream cheese product having the following composition:

| Ingredient | Percent By Weight |
|---|---|
| Cream Cheese | 96.600 |
| Potassium Sorbate | .099 |
| Water to Dissolve Potassium Sorbate | .099 |
| Sodium Stearoyl Lactylate | .146 |
| Phosphoric Acid | .244 |
| THERMFLO ® Starch | .939 |
| Sugar | .873 |
| Salt | 1.000 |

The organoleptic properties and the shelf-life of the cream cheese product were substantially the same as those set forth in Example I.

### EXAMPLE VI

The method of Example I was repeated, except that disodium phosphate was used as the emulsifying agent instead of sodium stearoyl lactylate. The composition of the cream cheese product was as follows:

| Ingredient | Percent By Weight |
|---|---|
| Cream Cheese | 97.921 |
| Potassium Sorbate | .090 |
| Water to Dissolve Potassium Sorbate | .090 |
| Di-sodium Phosphate | .500 |
| Phosphoric Acid | .460 |
| THERMFLO ® starch | .939 |

The organoleptic properties and the shelf-life of the cream cheese product were substantially the same as those set forth in Example I.

### EXAMPLE VII

A cheesecake-flavored cream cheese is heated to about 105 F (65.5° C.) by means of direct steam injection. The added ingredients were added and the product processed in the manner described in Example I with the sugar added with the starch.

The resultant product formulation was as follows:

| Ingredient | Percent By Weight |
|---|---|
| Flavored Cream Cheese | 92.27 |
| Potassium Sorbate (50% solution) | 0.19 |
| Chemical Emulsifier | 0.14 |
| Phosphate Acid | 0.23 |
| Modified Starch | 0.89 |
| Sugar | 0.62 |
| Steam Condensate | 5.66 |

The resultant product has oxganoleptic properties comparable to the starting flavored cream cheese and also possesses extended, room-temperature shelf life.

### EXAMPLE VIII

A strawberry-flavored cream cheese containing both strawberry sauce and natural strawberry flavor was prepared as in Example VII with the TBHQ antioxidant being added with the potassium sorbate solution. The resultant product formulation was as follows:

| Ingredient | Percent By Weight |
|---|---|
| Flavored Cream Cheese | 91.75 |
| Potassium Sorbate (50% solution) | 0.30 |
| Chemical Emulsifier | 0.15 |
| Phosphoric Acid | 0.30 |
| Modified Starch | 0.88 |
| Sugar | 0.66 |
| Disodium Phosphate | 0.30 |
| Steam Condensate | 5.65 |
| TBHQ | 0.002 |

The resultant product has organoleptic properties comparable to the starting flavored cream cheese and also possesses extended, room-temperature shelf life.

### EXAMPLE IX

A cream cheese product is prepared in accordance with the procedure of Example VII using a cream cheese substitute in place of the flavored cream cheese. The cream cheese substitute (Kraft Cheesecake Blend, a product of Kraft Food Ingredients, Corp., Memphis, Tenn.) is comprised of milk, partially hydrogenated soybean oil, cheese culture, salt, carob bean gum, mono- and diglycerides, vitamin A and apocarotenal. Again the resultant product is comparable in organoleptic properties to the starting material while possessing extended, room-temperature shelf life.

It should be understood that the amount of edible acid to be added to the fluidized cream cheese material will vary depending on the pH of the cream cheese material which is utilized as the starting material. In the foregoing Examples I-IX sufficient acid was added to bring the final pH to between about 4.2 and 4.3.

While the present invention has been particularly described with reference to the specific embodiments set forth above, it should be understood that numerous modifications may be made by those skilled in the art without departing from the scope and spirit of the invention hereinafter claimed.

What is claimed is:

1. A cream cheese product storable at normal room temperatures for at least 6 months without substantial bacteriological deterioration, comprising cream cheese material and an added edible acid in an amount sufficient to provide a pH of less than about 4.5.

2. The cream cheese product of claim 1 further comprising an effective amount of added antimycotic agent.

3. The cream cheese product of claim 1 further comprising an effective amount of added anti-syneresis agent.

4. The cream cheese product of claim 1 further comprising an effective amount of added emulsifying agent.

5. The cream cheese product of claim 1 wherein the edible acid is present in an amount sufficient to provide a pH of 4.4 or less.

6. The cream cheese product of claim 1 wherein the edible acid is present in an amount to provide a pH of from about 4.2 to 4.4.

7. A method for making a cream cheese product storable at normal room temperatures for at least 6 months without substantial bacteriological deterioration, comprising the steps of heating cream cheese material to a temperature sufficient to fluidize the same; thereafter adding thereto and mixing an edible acid in an amount sufficient to provide a pH of less than about 4.5; thereafter heating to pasteurize the acidified mix; and then cooling and packaging the pasteurized mix.

8. The method of claim 7 further comprising the addition of an effective amount of an antimycotic agent to the fluidized cream cheese material.

9. The method of claim 7 further comprising the addition of an effective amount of an anti-syneresis agent to the fluidized cream cheese material.

10. The method of claim 7 further comprising the addition of an effective amount of an edible emulsifying agent to the fluidized cream cheese material.

11. The method of claim 7 wherein the edible acid is added in an amount sufficient to provide a pH of 4.4 or less.

12. The method of claim 7 wherein the edible acid is added in an amount to provide a pH of from about 4.2 to 4.4.
